(19) United States
(12) Patent Application Publication
(10) Pub. No.: US 2026/0037319 A1
(43) Pub. Date: Feb. 5, 2026

(54) MANAGING PLANS FOR DATA PROCESSING SYSTEMS USING REPRESENTATIONS OF INFERENCE MODEL PREDICTIONS

(71) Applicant: Dell Products L.P., Round Rock, TX (US)

(72) Inventors: OFIR EZRIELEV, Be'er Sheva (IL); HANNA YEHUDA, Acton, MA (US); YONIT LOPATINSKI, Shomria (IL)

(21) Appl. No.: 18/788,449

(22) Filed: Jul. 30, 2024

(51) Int. Cl. G06F 9/50

(52) U.S. Cl. CPC G06F 9/5038

(57) ABSTRACT

Methods and systems for managing operation of a data processing system are disclosed. To do so, potential future operations of the data processing system may be displayed to a viewer via a graphical user interface. User input may be obtained based on the potential future operations and a potential plan may be obtained based on the user input. The potential plan may include one or more actions to be performed at a point in time and limitations for enforcement of the potential plan. An impact of the potential plan may be simulated using acyclic graphs and the user may determine, based on the acyclic graphs, whether the potential plan is acceptable. The potential plan may be used as a plan for the data processing system and the limitations may be based on a statistical characterization of the potential future operations and a likelihood of an outcome for the plan occurring.

### FIELD

Embodiments disclosed herein relate generally to managing operation of data processing systems. More particularly, embodiments disclosed herein relate to systems and methods to manage plans for the data processing systems using representations of inference model predictions.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIG. 3A shows a first example of a representation of inference model predictions in accordance with an embodiment.

FIG. 3B shows a second example of a representation of inference model predictions in accordance with an embodiment.

FIG. 4A-4B show flow diagrams illustrating methods of managing operation of data processing systems in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services while in an operational state. Over time, operational states of the data processing system may change due to: (i) component failures (e.g., hardware and/or software components of the data processing system), (ii) introduction of new components to the data processing system that may reduce (or improve) operational efficiency and/or functionality of the data processing system, (iii) changes in environmental factors (e.g., changes in external conditions for the data processing system, such as operating environment temperatures, power source availability, etc.), and/or (iv) other types of events or conditions that may result in changes to a current operational state of the data processing system. For example, the occurrences of such events may affect the availability of resources (e.g., external resources, hardware/software components of a data processing system) used to provide the computer-implemented services.

To manage changes in operation of the data processing system, at least one inference model may be used to generate a plurality of predictions (e.g., simulations, inferences) regarding a future state for the data processing system over time. For example, the inference model may predict future states for the data processing system, based on the ingest data. By generating the plurality of predictions to predict a future state at a particular time, variability in the plurality of predictions may be characterized (e.g., a statistical characterization may be obtained indicating agreement in the plurality of predictions). Consequently, the variability in the plurality of predictions may be considered when making decisions based on the predicted future states indicated by the plurality of predictions.

Policies for the data processing system may be keyed to the predicted future states. Therefore, the policies may be identified (e.g., from a set of existing policies and/or new policies may be created in view of the predicted future states) and invoked in order to manage undesired outcomes of the predicted future states. For example, a policy for the data processing system may define how the data processing system is to operate while in the predicted future state (e.g., to manage outcomes associated with the predicted future state), thereby indicating a manner in which the resources of the data processing system are to be distributed and/or otherwise accounted for so that the computer-implemented services may continue to be provided. To increase a likelihood of selecting a relevant policy, the policies may be keyed, at least in part, to quantifications of the statistical characterization.

For example, a policy may be keyed to conditions associated with a future state for the data processing system. However, the policy may indicate that an action set associated with the policy may only be implemented if a standard deviation for the plurality of predictions is sufficiently low (e.g., based on any threshold for the standard deviation). Therefore, the policy may not be invoked if a degree of variability in the plurality of predictions indicates that the predicted future state is not sufficiently likely to warrant implementation of the policy.

The inference model(s) may predict multiple future states for the data processing system over time, some of which may be dependent on one another. For example, a likelihood of an occurrence of a state may be dependent on occurrences of any number of preceding states. Therefore, as a result of running a plurality of simulations to generate such predictions, the inference model(s) may generate large volumes of complex (e.g., interrelated, partially dependent) data.

To improve interpretability of the data and, therefore, increase a likelihood of providing desired computer-implemented services, the plurality of predictions may be represented using an acyclic graph. The acyclic graph may be defined based on statistical characterizations of the predictions and may provide for visual interpretation of a reduced size representation of the large volumes of complex data. For example, the acyclic graph may include nodes representing clusters of predicted future states, connected by edges representing likelihoods of transitions between the clusters over time. A user (e.g., an SME) or other entity may interact with the acyclic graph to manage policy definition for the data processing system.

The acyclic graph may display any number of potential future operations (e.g., future states) for the data processing system at various time intervals. However, if a system represented by the acyclic graph is complex (e.g., includes multiple data processing systems, operates in an environment with frequent fluctuating conditions), policy definition may become challenging. Policy definition may be challenging for complex systems due to same policies being invoked at multiple time intervals and/or due to multiple policies being invoked at any given time interval.

To manage operation of the data processing system when policy definition is insufficient to account for desired operation of the data processing system, a plan may be generated for the data processing system. The plan may include actions that are: (i) time-restricted (e.g., only to be performed at a particular time and are only applied once), (ii) limited based on a quantification of least one statistical characterization meeting criteria, and/or (iii) further limited based on a likelihood that implementation of the plan will yield a desired result. By defining (e.g., via user interaction with a graphical user interface (GUI)) the plan, a likelihood that an undesirable outcome may occur for the operation of the data processing system may be reduced and an overall number of policies likely to be invoked may be reduced thereby conserving computational resources.

Thus, embodiments disclosed herein may address, among other technical problems, the technical challenge of proactive plan management for a data processing system based on a plurality of predicted future states for the data processing system. By using an acyclic graph to represent the predicted future states and statistical characterizations thereof, context and clarity regarding future states that are predicted to occur in a series over time (e.g., streams of future states) may be introduced to improve plan management. Plans for the data processing system may be managed (e.g., defined) in accordance with likely predicted future states, and remedial actions may be implemented in a time-restricted manner based on the plans to increase a likelihood of the computer-implemented services being provided to downstream consumers of the services as desired.

In an embodiment, a method for managing operation of a data processing system is provided. The method may include: displaying, to a user and via a graphical user interface, potential future operations of the data processing system; obtaining, from the user, user input based on the potential future operations of the data processing system; obtaining, based on the user input, a plan that: may be for a point in time indicated by the graphical user interface, may be limited for use by the data processing system based on a statistical characterization of the potential future operations of the data processing system, and may define activity of the data processing system at the point in time; and providing computer-implemented services using the data processing system and the plan.

The graphical user interface may include an acyclic graph indicating any number of different potential future operation of the potential future operations, and may include probabilities of each different future operation of the potential future operations occurring.

The user input may indicate that at least one of the probabilities may be used as at least a part of the statistical characterization.

Obtaining the plan may include: updating the graphical user interface to indicate an impact of a potential plan defined by the user; obtaining, from the user, confirmation regarding acceptability of the impact; and in a first instance of the obtaining where the impact is acceptable: using the potential plan as the plan; and in a second instance of the obtaining where the impact is not acceptable: evaluating other potential plans defined by the user to obtain the plan.

Updating the graphical user interface may include: updating nodes of an acyclic graph of the graphical user interface to indicate an occurrence of a new potential future operation based on the potential plan.

Updating the graphical user interface may include: updating edges between nodes of an acyclic graph of the graphical user interface to indicate a change in likelihood of occurrence of the potential future operations based on the potential plan.

Updating the graphical user interface may include: adding an acyclic graph that indicates updated potential future operations of the data processing system with the plan being enforced by the data processing system.

The graphical user interface may include a second acyclic graph that indicates the potential future operations of the data processing system without the plan being enforced by the data processing system.

Providing the computer-implemented services may include instructing the data processing system to perform the plan.

The plan may be further limited for use based on a likelihood of an outcome for the plan occurring.

A non-transitory media may include instructions that when executed by a processor cause the computer-implemented method to be performed.

A data processing system may include the non-transitory media and a processor, and may perform the computer-implemented method when the computer instructions are executed by the processor.

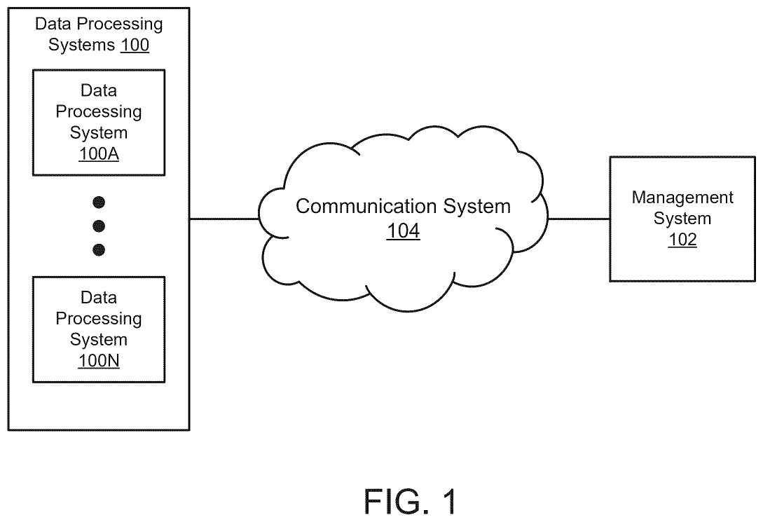

Turning to FIG. 1, a block diagram illustrating a system in accordance with an embodiment is shown. The system shown in FIG. 1 may provide for management of data processing systems that may provide, at least in part, computer-implemented services. The computer-implemented services may include any type and quantity of services including, for example, data services (e.g., data storage, generation, access and/or control services), communication services (e.g., instant messaging services, video-conferencing services), and/or any other type of service that may be implemented with a computing device. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

The system may include any number and/or type of data processing systems 100 (e.g., 100A-100N). Data processing systems 100 may include any number of hardware components (e.g., processors, memory modules, storage devices, communications devices). The hardware components may support execution of any number and type of applications (e.g., software components). Changes in available functionalities of the hardware and/or software components may provide for various types of different computer-implemented services to be provided over time.

The computer-implemented services may be provided in accordance with policies for data processing systems 100. For example, a policy may define actions for managing operation of any of data processing systems 100 and/or may be triggered when any of data processing systems 100 enter an operational state keyed to the policy. The policies may be defined and invoked to achieve operational goals for data processing systems 100.

For example, data processing systems 100 may include robotic entities such as unmanned aerial vehicles (e.g., drones) used to provide agriculture management services. To provide the agriculture management services, the drones may be deployed to a geographic location (e.g., a field used to produce crops) to spray portions of the field with pesticide in accordance with policies for the drones. For example, to ensure a desired coverage of the field with pesticide, the policies may define specific numbers of drones to be deployed at specific times (e.g., under specific circumstances).

To proactively manage operation of data processing systems 100 in view of the operational goals, an inference model may be used to generate predictions based on ingest data regarding occurrences of future states that may impact provision of the computer-implemented services (e.g., performance data of components of the data processing systems, sensor data collected by the data processing systems, observational weather data collected by doppler radar, radiosondes, weather satellites, buoys, etc.). At least a portion of the states may be interpreted as events (e.g., weather events and/or other events which may impact the operation of data processing systems 100).

However, predictions obtained using the inference model may be unreliable for proactively managing operation of data processing systems 100. For example, the inference model may be unable to generate predictions that meet the needs of a downstream consumer of the predictions due to poor training or validation processes, poor training data quality, and/or for other reasons. Additionally, the predictions may include stochastic elements (e.g., random variance in one or more parameters over time) which may result in prediction variability. Prediction variability may reduce a reliability of using the predictions as a basis for making decisions.

Returning to the above example, the inference model may predict that a weather event is unlikely to adversely impact an ability of the drones to perform the agriculture management services (e.g., based on any criteria for degrees of likelihood). If the prediction is inaccurate (e.g., if the weather event adversely impacts the ability of the drones to spray pesticide as desired during and/or following the weather event), then the computer-implemented agriculture management services may be of a reduced quality, interrupted, and/or delayed.

Therefore, to reduce the effects of prediction variability, a plurality of predictions regarding occurrences of future states for data processing systems 100 may be generated. The plurality of predictions may be generated by performing multiple simulations using at least one inference model. The simulations may be run by providing same or similar ingest data to the inference model(s) in multiple instances. When more than one inference model is used, the inference models may be of varying types and/or sizes, and the inference models may be trained using differing training datasets and/or optimization algorithms.

The plurality of predictions obtained using the inference model(s) may be statistically analyzed to obtain a statistical characterization indicating agreement in the plurality of predictions. The statistical characterization, input data for the inference model(s), and/or the plurality of predictions may be utilized to obtain a policy for updating operation of data processing systems 100 thereby accounting for variability in the plurality of predictions.

However, the plurality of predictions and any statistical analysis thereof may be difficult to analyze and/or interpret for decision-making purposes due to the plurality of predictions occupying a large volume of complex data (e.g., complexity due to a dependent nature of portions of the plurality of predictions). For example, some occurrences of the predicted future states may be dependent on one another and may contribute to streams of predicted future states (e.g., sequences of dependent states that occur over time and/or as a result of one another). This may result in large amounts of complex time dependent data that may be difficult to analyze and/or interpret by entities that manage policies for and/or operation of data processing systems 100.

Returning to the drone example, at least one inference model may be used to generate predictions regarding occurrences of states (e.g., including any number of events) which may impact the ability of the drones to provide the agriculture management services. For example, the inference model(s) may generate predictions regarding likelihoods that strong winds may adversely affect the drones' ability to spray pesticide over a crop when operating at velocities defined by a nominal flight policy (e.g., the nominal flight policy may include flight patterns that are appropriate in low wind conditions). Therefore, the predictions may indicate that the drones may experience a damaged state and/or may be unable to properly distribute the pesticide over the crop if deployed in the strong winds based on the low wind flight pattern.

Therefore, the inference model(s) may be prompted to run multiple simulations using various flight patterns (e.g., ingest data describing different velocity information than what is defined by the nominal flight policy). For example, a test flight pattern may instruct the drones to fly into the direction of the strong winds at higher speeds than nominal, instead of a crosswind flight pattern defined by the nominal flight policy). Based on each test flight pattern, dependent future events (e.g., usable to define future states) may be predicted for the drones. For example, the drones may be predicted to have difficulty changing direction at edges of the crop under strong wind conditions and/or the drones may be predicted to perform the services at varying levels of cost efficiency (e.g., the drones may operate in a time inefficient state, in a high energy utilization state, in a high risk (of damage) state).

As a result, the inference model(s) may generate predictions regarding a large number of future events over time (e.g., relating to each test flight pattern scenario), and some of the predicted future events may be dependent on other (preceding) predicted future events. To properly consider (e.g., measure) effects and/or outcomes of each test flight pattern, the large number of predicted future events may be reduced in size (e.g., via clustering of future events) and may be represented using an acyclic graph.

Therefore, to manage operation of data processing systems based on predicted future states for the data processing systems, a plurality of predictions may be generated using at least one inference model trained to predict future states for the data processing systems. The plurality of predictions may be time-dependent, and therefore may be analyzed in aggregate (e.g., within a time period) using statistical techniques to obtain statistical characterizations (e.g., ratio, mean, median, mode, standard deviation). The statistical characterizations may be used to define clusters (e.g., group predicted future states generated due to a statistical variance in the predictions).

To improve analysis and/or interpretation of the plurality of predictions and statistical characterizations thereof, the clusters (e.g., predicted future states) may be represented using an acyclic (temporal) graph. Based on the statistical characterizations, the acyclic graph may provide for context when interpreting likelihoods of the data processing systems experiencing the predicted future states. The acyclic graph may be analyzed in view of operational goals for the data processing systems in order to define (e.g., created, update, supersede) policies that define operation of the data processing systems. Doing so may increase a likelihood of avoiding occurrences of predicted future states associated with negative outcomes and/or may increase a likelihood of promoting occurrences of predicted future states associated with positive outcomes.

However, as a complexity of the system simulated by the acyclic graph increases, a number of predicted future operations (e.g., the predicted future states) represented on the acyclic graph may also increase. This may occur, for example, if a system simulated by the inference model(s) includes a large number of data processing systems and/or operates under frequently fluctuating conditions. As the number of predicted future states increases, policies may increase in complexity and, therefore, a computational cost to define and implement the policies may also increase. Complexity of a policy may increase, for example, if a same policy may be invoked for multiple predicted future states and/or multiple policies may be invoked for each predicted future state.

In addition, an additional acyclic graph may be generated (e.g., based on simulated conditions generated by a digital twin) to display predicted future operations for data processing systems 100 in view of implementation of one or more policies. However, as a complexity of the policy increases, a complexity of the additional acyclic graph may increase thereby reducing a likelihood that an SME (and/or automated system) may efficiently interpret and/or manage implementation of the policy. Consequently, an undesirable quantity of computational resources may be consumed during policy definition and/or a likelihood of providing computer-implemented services as desired may be reduced.

In general, embodiments disclosed herein may provide methods, systems, and/or devices for defining plans to manage operation of one or more data processing systems. Obtaining a plan may include user interaction with the GUI representing the acyclic graph. The user may identify one or more undesired future operation of data processing systems 100 and may select a potential action to be performed at a point in time to reduce a likelihood of an outcome of the one or more undesired future operation. Following selection of the potential action, operation of data processing systems 100 may be simulated in view of enforcement of the potential plan for the data processing system (e.g., by a digital twin). As a result, the acyclic graph may be updated (e.g., nodes may be updated, edges between the nodes may be updated) to display potential future operations of data processing systems 100 with the plan being enforced. The GUI may be updated so that a second acyclic graph is viewable by a user, the second acyclic graph displaying potential future operation of the data processing system when the plan is not enforced for the data processing system.

A plan may include actions to be performed under a set of conditions. The set of conditions may include: (i) a time requirement (e.g., for the plan to be implemented at a particular time), (ii) a requirement for a statistical characterization based on the plurality of predictions (e.g., a likelihood of a state occurring for the data processing system meeting criteria), (iii) a likelihood that enforcing the plan accomplishes a goal (e.g., an operational goal for the data processing system) meets a threshold, and/or (iv) other requirements.

By doing so, a system in accordance with an embodiment may be used to manage plans for data processing systems in a manner that provides context (e.g., explainability) to predicted future states of the data processing systems. By analyzing clusters of predictions using the acyclic graph, plans may be dynamically generated and a user may interact with a GUI to visualize an impact of implementing the plan (e.g., via a side-by-side comparison of an updated acyclic graph representing the system when the plan is enforced and a second acyclic graph representing the system when the plan is not enforced). In addition, action sets performed based on the plans may be implemented to manage operation of the data processing systems in a manner that increases a likelihood of the data processing systems providing the computer-implemented services as desired.

To perform the above-noted functionality, the system of FIG. 1 may include data processing systems 100, and/or management system 102. Data processing systems 100, management system 102, and/or any other type of device not shown in FIG. 1 may perform all, or a portion of, the computer-implemented services independently and/or cooperatively. Each of these components is discussed below.

Data processing systems 100 may include any number and/or type of data processing systems (e.g., 100A-100N), which may include any number of hardware and/or software components configured to provide computer-implemented services. While providing the computer-implemented services, data processing systems 100 may generate data, such as telemetry data, performance data, sensor data, and/or other data related to operation of data processing systems 100. The data generated by data processing systems 100 may be provided to management system 102, which may provide device management services for data processing systems 100. For example, the data provided to management system 102 by data processing systems 100 may include training data usable to train inference models managed by management system 102 and/or input data usable as ingest for inference models managed by management system 102.

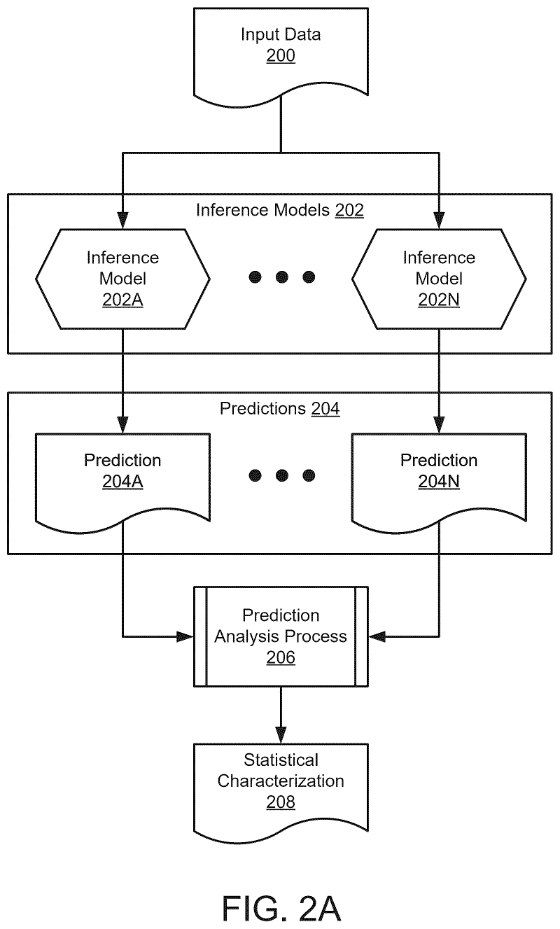

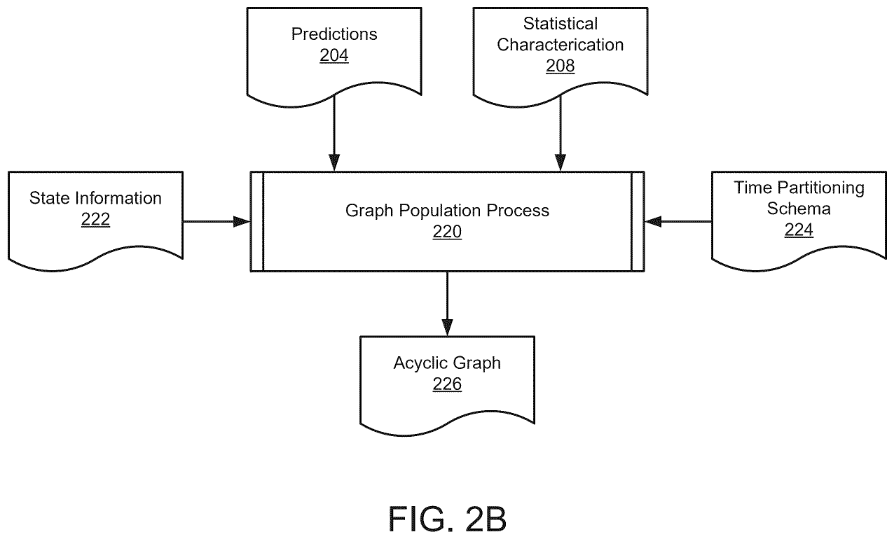

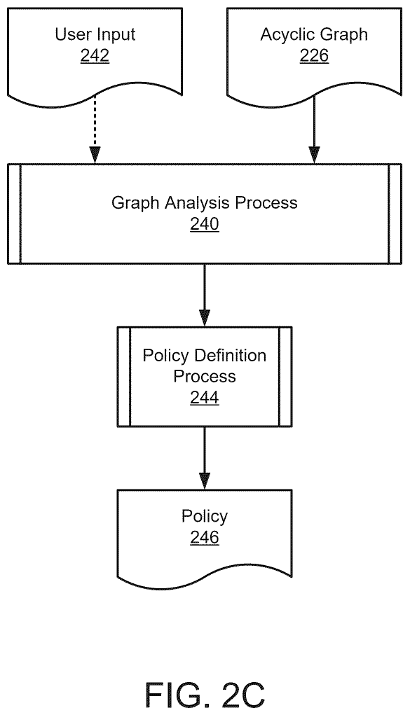

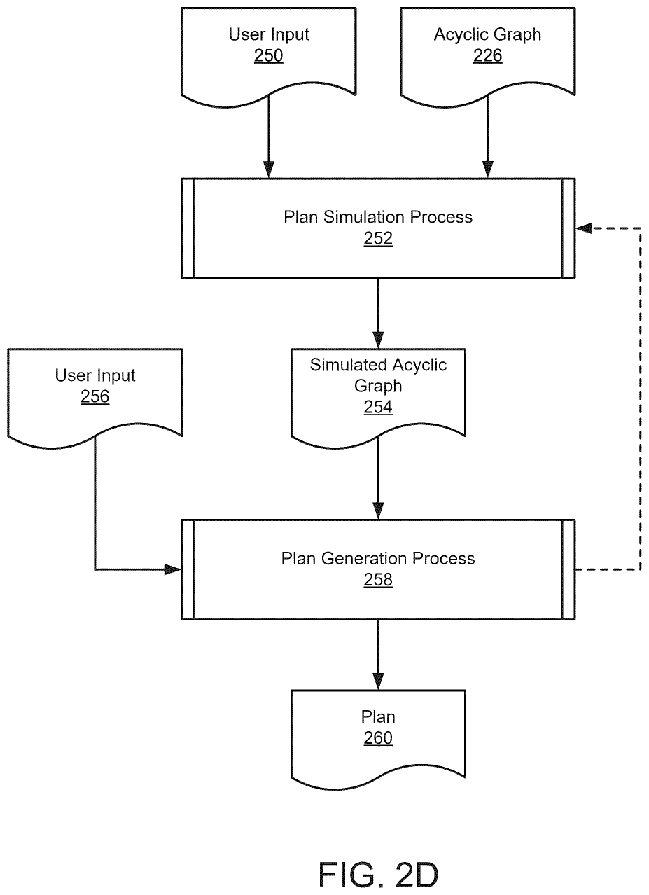

Management system 102 may include any number and/or type of devices (e.g., other data processing systems, servers, storage devices, user devices) that may be used to provide the device management services. As part of providing the device management services, management system 102 may manage (e.g., train and/or host) any number and/or type of inference models. For example, management system 102 may (i) obtain data (e.g., from data processing systems 100, from other data sources) such as training data and/or input (e.g., ingest) data for inference models, (ii) process the data (e.g., data interpolation, extraction, transformation), (iii) train any number of inference models (e.g., to predict future states for data processing systems 100) using the training data, (iv) generate a plurality of predictions (e.g. using the input data) regarding future states for data processing systems 100 (e.g., including events that may occur at any future point in time, over a duration of time beginning at a future point in time), and/or (v) analyze the predictions using statistical techniques (e.g., to obtain statistical characterizations for the predictions). For more information regarding management of inference models and inference model predictions, refer to the discussion of FIG. 2A.

To perform device management services related to policy and/or plan management for data processing systems 100, management system 102 may (i) obtain (e.g., populate) acyclic graphs representing the predictions and/or statistical characterizations thereof, (ii) facilitate analysis of the acyclic graphs (e.g., by a user or other entity) so that policies and/or plans for data processing systems 100 may be defined based on the analysis, and/or (iii) perform other actions for managing operation of data processing systems 100 (e.g., initiate and/or perform action sets associated with the policies and/or plans).

The plans and/or policies may define how data processing systems 100 are to operate in view of operational goals (e.g., operational goals for data processing systems 100, operational goals that relate to the computer-implemented services provided by data processing systems 100).

For example, to obtain the acyclic graphs, management system 102 may perform graph population processes using statistical characterizations for the plurality of predictions in order to define clusters of the predicted future states. The clusters may represent predicted future states that are considered same or similar (e.g., based on the statistical characterizations and criteria for clustering). By doing so, a reduced size representation of the plurality of predictions may be obtained to improve clarity during analysis of potential future states. Management system 102 may use the clusters and/or other information (e.g., likelihoods of event occurrences based on the statistical characterizations, outcome information) to obtain the acyclic graphs. For more information regarding obtaining acyclic graphs, refer to the discussion of FIG. 2B.

To facilitate analysis of the acyclic graphs for obtaining plans, management system 102 may: (i) display, to a user and via a GUI, potential future operations of the data processing system (e.g., the predicted and/or simulated states), (ii) obtain, from the user, user input based on the potential future operations of the data processing system, (iii) obtain, based on the user input, a plan, (iv) facilitate provision of computer-implemented services using the data processing system and the plan, and/or (v) perform other actions.

The plan may include restrictions (e.g., limits) for implementation based on: (i) a point in time indicated by the acyclic graph, (ii) a statistical characterization of the potential future operations (e.g., states) of the data processing system, and/or (iii) a likelihood of an outcome (e.g., a desired outcome) for the plan occurring. The plan may, therefore, define activity of the data processing system at the point in time for which the plan is intended to be enforced.

The user may select any predicted future operation (e.g., predicted future state) of data processing systems 100 via an interaction with the GUI displaying the acyclic graph. By selecting a predicted future operation, the user may build a plan including one or more actions to be performed at a future time associated with the selected predicted future operation (e.g., corresponding to a cluster on the acyclic graph).

To perform plan management services, management system 102 may host and operate a digital twin usable to simulate potential future operations of data processing systems 100 based on current operations and/or parameters for the simulation such as the potential plan.

The digital twin may, therefore, simulate potential future operations for data processing systems 100 in view of the potential plan built by the user. As a result, the acyclic graph may be updated to include updated nodes representing occurrences of new potential future operations and updated edges (e.g., representing changes in likelihood of occurrences of the potential future operations) based on the potential plan. The GUI may include a second acyclic graph displaying potential future operations of data processing systems 100 without the potential plan being enforced to facilitate comparison by the user.

If the impact of enforcement of the potential plan (as shown by the updated acyclic graph) is confirmed as acceptable by the user, the potential plan may be used as the plan. If the impact is not confirmed as acceptable, additional potential plans may be simulated and evaluated to obtain the plan. For more information regarding obtaining plans using acyclic graphs, refer to the discussion of FIG. 2D.

Thus, device management services for data processing systems 100 may be provided by management system 102. By doing so, a plurality of predictions generated by the inference model(s) may be analyzed using various statistical techniques in order to populate an acyclic graph usable for plan management. Based on an analysis of the acyclic graph, plans for data processing systems 100 may be obtained for use in managing operation of data processing system 100. For example, actions may be performed as defined by the plan in order to manage effects of undesired outcomes associated with predicted future states for the data processing system. As a result, the provided computer-implemented services may be more reliable and less likely to be interrupted and/or delayed.

When providing their functionality, any of data processing systems 100, and/or management system 102 may perform all, or a portion, of the processes, interactions, and methods illustrated in FIGS. 2A-4B.

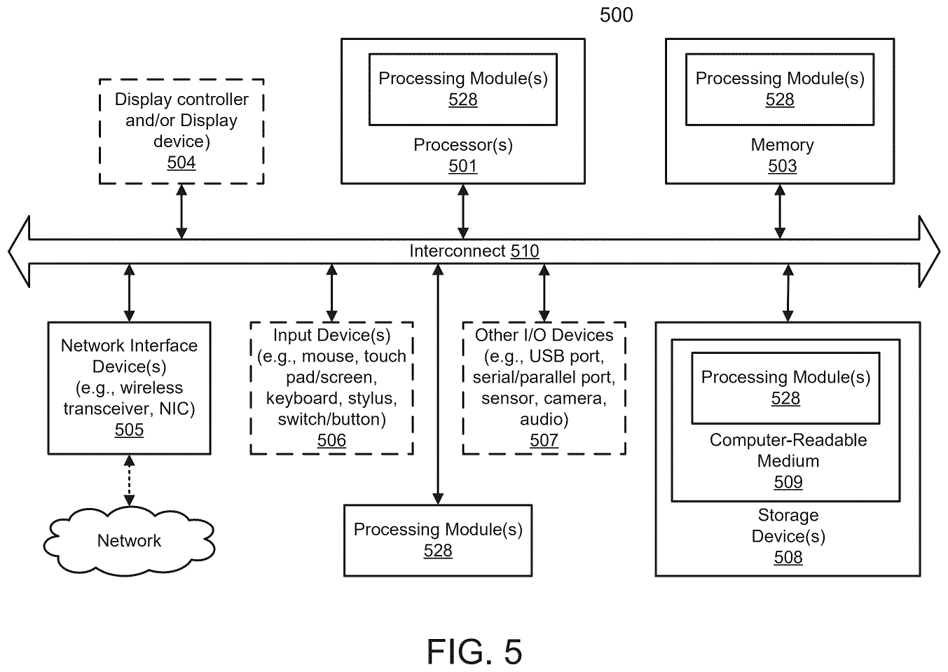

Any of data processing systems 100 and/or management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 5.

Any of the components illustrated in FIG. 1 may be operably connected to each other (and/or components not illustrated) with communication system 104. Communication system 104 may facilitate communications between the components of FIG. 1. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein. For example, while the system of FIG. 1 shows a single management system (e.g., 102), it will be appreciated that the system may include any number of management systems.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 200, 208) is used to represent data structures, a second set of shapes (e.g., 206, 220) is used to represent processes performed using and/or that generate data, and a third set of shapes (e.g., 202A, 202N) is used to represent inference models.

Turning to FIG. 2A, a first data flow diagram in accordance with an embodiment is shown. The first data flow diagram may illustrate data used in and data processing performed in obtaining statistical characterizations for a plurality of predictions generated using at least one inference model.

To obtain a statistical characterization, input data 200 may be used as ingest to generate predictions using inference models 202. Inference models 202 may be hosted by a management system (e.g., management system 102, not shown) responsible for managing operation of data processing systems used to provide computer-implemented services (e.g., data processing systems 100, not shown). Input data 200 may include any type and/or quantity of data, including data generated by data processing systems 100 (e.g., collected using sensors, telemetry data, performance data) and/or data from any other data source (e.g., databases, other management systems, other data processing systems).

Input data 200 may be provided to inference models 202 and used as ingest to generate predictions. Inference models 202 may include any type and/or any quantity of inference models (e.g., 202A-202N). For example, inference models 202 may include machine learning models (e.g., decision tree, quantile regression) and/or simulation models (e.g., deterministic simulation, computationally-driven simulation, dynamic simulation, analytical simulation). Inference models 202 may be trained using training data which defines goals for predictions made by the inference models. Parameters of the inference models may be selected using an optimization process (e.g., an objective function may be defined in terms of the training data and predictions made by the inference models, and a global optimization method such as gradient descent may be used to identify parameters that most faithfully reproduce the trends in the training data).

Once the parameters of an inference model (e.g., inference model 202A) are set, then the inference model may be used to make predictions. A single inference model (e.g., 202A) may be used to generate predictions and/or a plurality of inference models (e.g., 202A-202N) may be used to generate predictions. Differences in model type, training data, and/or the optimization process may result in variability between the predictions made by the inference models, even when the predictions are generated using the same (and/or substantially the same) input dataset. Additionally, stochastic elements (e.g., random variance in one or more parameters over time) may result in prediction variability (e.g., within a single model and/or simulation) for a given set of conditions.

The input dataset used as ingest for inference models 202 (e.g., input data 200) to generate predictions may be substantially the same for each prediction. For example, substantially the same input data may include criteria which permit up to a 10% difference in the input data (e.g., at least 90% of the input data is the same). In a second example, the criteria may indicate that the input data may only differ by 5% to be considered substantially the same (e.g., at least 95% of the input data is the same). In a third example, the criteria may indicate that the input data may differ by 25% to be considered substantially the same (e.g., at least 75% of the input data is the same).

Input data 200 may be ingested by inference models 202, and predictions 204 may be generated as output. Predictions 204 may include a plurality of predictions (e.g., 204A-204N) generated by respective inference models that each predict occurrence of a future state (e.g., a state that may occur at any future point in time, over a duration of time beginning at any future point in time). For example, predictions 204 may include predictions regarding states which may impact the operation of data processing systems 100, including events such as changes in temperature, resource availability (e.g., forecasted changes in power supply and/or demand), weather conditions (e.g., rain, hail, wind), and/or any other events which may impact the devices.

For example, data processing systems 100 may include edge devices managed by management system 102, which may include smart streetlights in a region. The smart streetlights may be implemented to conserve power by adjusting the amount of light generated based on data collected by sensors. The data collected by the sensors may include data regarding brightness, humidity, motion, temperature, etc. The data may be provided to management system 102 and used, at least in part, as input data for at least one inference model used to generate predictions regarding the occurrence of events which may impact the operation of the smart streetlights.

The plurality of predictions (e.g., predictions 204A-204N) may be used to perform prediction analysis process 206. During prediction analysis process 206, predictions 204 may be analyzed in aggregate to obtain a statistical characterization (e.g., statistical characterization 208) regarding agreement in the plurality of predictions. The statistical characterization may be obtained using any type and/or quantity of statistical methods (e.g., techniques, calculations, data fitting), including averaging, population distribution calculations, hypothesis testing, regression, analysis of variance, and/or any other type of statistical methods. The statistical characterization may include a ratio, mean, median, mode, and/or standard deviation for predictions 204.

Continuing with the above example, the at least one inference model may generate predictions based on the sensor data and/or data from other sources regarding an increase in temperature which may affect operation of 100 smart streetlights (e.g., the operation may be impacted to an undesirable degree if the operation continues in the current operating state). For example, temperature data collected by the sensors and temperature data collected from weather satellites may be used as input data for 20 inference models. Of the 20 inference models, 5 may generate predictions indicating the temperature will affect operation of 60 smart streetlights, 10 may generate predictions indicting the temperature will affect operation of 80 smart streetlights, 3 may generate predictions indicating the temperature will affect operation of 75 smart streetlights, and 2 may generate predictions indicting the temperature will affect operation of 10 smart streetlights.

A prediction analysis process may be used to analyze the predictions using statistical methods to obtain statistical characterizations such as a median (e.g., 77.5 smart streetlights will be affected) and a standard deviation (e.g., 21.3 smart streetlights).

Statistical characterization 208 may include any number of statistical characterizations for the predictions. For example, the statistical characterizations may be used to define clusters of future predicted events over defined periods of time (e.g., based on levels of agreement of the predicted future events within the defined periods of time and criteria associated with quantities of the statistical characterizations). The clusters may represent predicted future states as defined by the future predicted events, and the statistical characterizations may be used to quantify likelihoods of transitions between the predicted future states.

Thus, by implementing the data flow shown in FIG. 2A, a system in accordance with embodiments disclosed herein may be used to obtain statistical characterizations for a plurality of predictions generated by at least one inference model. The statistical characterizations may indicate variability in the predictions, and may be used to prepare the prediction data for further analysis.

While described herein as the inference model(s) generating predictions regarding occurrences of future states for a data processing system, it may be appreciated that the inference model(s) may generate predictions regarding future events and/or other conditions for the data processing system, which may be usable to define operational states for the data processing system.

Turning to FIG. 2B, a second data flow diagram in accordance with an embodiment is shown. The second data flow diagram may illustrate data used in and data processing performed in obtaining an acyclic graph based on a plurality of predictions and statistical characterizations for the plurality of predictions.

To obtain the acyclic graph, graph population process 220 may be performed. During graph population process 220, predictions 204, statistical characterization 208, state information 222 and/or time partitioning schema 224 may be used to obtain acyclic graph 226.

For example, predictions 204 may include a plurality of predictions obtained using at least one inference model trained to predict future states for a data processing system over time (e.g., as described with respect to FIGS. 1-2A). Predictions 204 may include dependent (e.g., temporally dependent) predicted future states for the data processing system. For example, occurrences of some portions of predictions 204 may depend on prior occurrences of other portions of predictions 204.

Predictions 204 may include temporal elements. For example, portions of predictions 204 (e.g., a predicated future event for the data processing system) may be associated with a future point in time and/or a duration of time). To analyze predictions 204 with respect to time, predictions 204 may be partitioned into time periods (or points in time) using time partitioning schema 224. Time partitioning schema may include information usable to define time points and/or time periods for acyclic graph 226. Time partitioning schema 224 may be predetermined, may be customizable (e.g., by a user), and/or may be determined based on time information of predictions 204.

Once predictions 204 are partitioned by time, during graph population process 220, predicted future states may be obtained. To do so, graph population process 220 may include a clustering process for predictions 204. The clustering process may be performed using any type of clustering algorithm (e.g., k-means clustering, mean-shift clustering, rule-based clustering) and/or statistical characterization 208. As discussed with respect to FIG. 2A, statistical characterization 208 may include different types of statistical characterizations for predictions 204. For example, the clustering algorithm may use any of the different types of statistical characterizations of predictions 204 to define clusters of predicted future events for each time partition.

The clusters may, for example, be defined based on similar and/or same predicted future events for the data processing system (e.g., similarity being based on some criteria corresponding to quantities of any of statistical characterization 208). The predicted future events of each cluster may be used to define a predicted future state. For example, if events of a cluster include failure of a crucial hardware component of the data processing system (e.g., a motherboard), then data processing system may be in a non-operational state during the time period or at the time point for which the cluster is defined. Therefore, each cluster may indicate a predicted future state for the data processing system.

State information 222 may include information regarding a current state of the data processing system and/or other information regarding other types of (e.g., predefined) states for the data processing system. For example, state information 222 may include specific outcomes associated with operational states for the data processing system, levels of severity of the outcomes, levels of priority for administrator intervention, and/or other information regarding the operational states.

State information 222 may be used, along with other data, to populate metadata for each cluster. For example, a cluster indicating a non-operational state for the data processing system may be associated with a negative outcome (e.g., unable to provide computer-implemented services) and a level of priority indicating immediate administrator attention is required. Or, for example, a cluster indicating that the data processing system is operating in a high-capacity state (e.g., the data processing system is operating at or near capacity limits of portions of its hardware resources) may be associated with a positive outcome (e.g., the computer-implemented services are lucrative) and a level of priority indicating administrator attention is required within a specified period of time, although not immediately.

Metadata for each cluster may include, for example, (i) information regarding the predicted future state (e.g., severity levels, positive/negative outcomes), (ii) whether policies are keyed to the predicted future state, (iii) a number of simulations and/or inference models that predicted the future events included in the cluster, (iv) information regarding variability in predicted future states (e.g., time partitioned groups of predictions), and/or (v) any other data associated with the cluster (e.g., from state information 222, predictions 204, statistical characterization 208, and/or time partitioning schema 224).

For example, data from state information 222, predictions 204, statistical characterization 208, time partitioning schema 224, and/or other data structures or sources may be input to an inference model such as a large language model (LLM) for summarization and/or interpretation. Thus, the metadata for each cluster may include human interpretable text generated by an LLM.

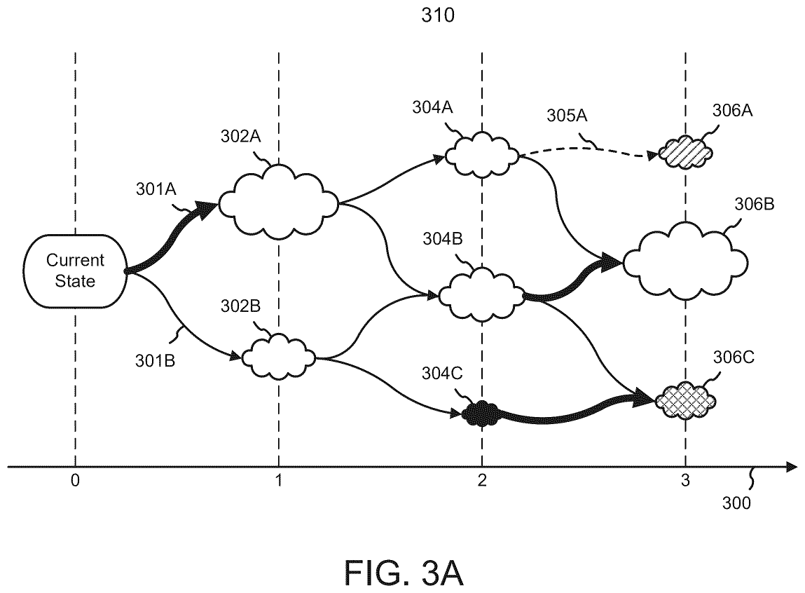

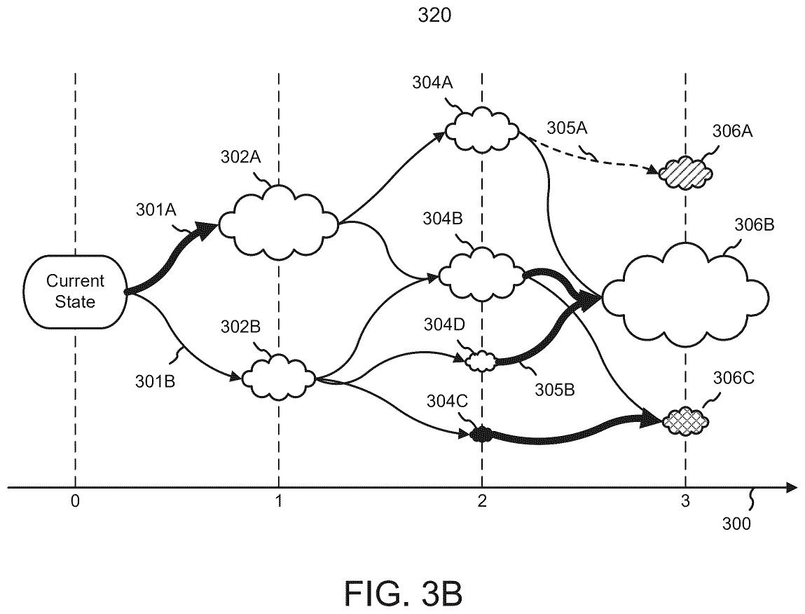

Acyclic graph 226 may include a plurality of nodes connected by a plurality of edges. For example, the nodes may represent the clusters of the predicted future states, and the clusters may be connected by edges based on their dependencies. The edges may indicate temporally dependent relationships between the clusters and/or other types of relationships such as likelihoods of transitions between occurrences of the predicted future states of the clusters of the time partitions. An example of an acyclic graph that may be obtained during graph population process 220 is shown in FIG. 3A.

Turning to FIG. 3A, a first example of an acyclic graph is shown in accordance with an embodiment. FIG. 3A shows directed acyclic graph 310 that includes a plurality of nodes (e.g., 302A-306A, 302B-306B, 304C-306C) represented by a cloud shape, and some of the nodes are connected by a plurality of edges (e.g., 301A, 305A, 301B) represented using arrows. Each of the nodes may represent clusters of predicted future states for the data processing system. Each of the edges connecting the nodes may represent relationships between the clusters (e.g., relationships based on metadata of the clusters). For example, the arrows may indicate directional dependencies (e.g., order in a time series of predicted states). For practical purposes, while describing FIG. 3A the nodes may be referred to as predicted (future) states. For example, node 302A may be referred to as predicted state 302A.

The predicted states for the data processing system may be arranged over time (e.g., in accordance with their time partition) on a horizontal time axis with time increasing to the right, as indicated by arrow 300. Along the horizontal time axis are simulated time periods/points/steps (e.g., 0, 1, 2, 3) corresponding to the time partitioned predicted states, with time period 0 being a present time (e.g., a current state of operation of the data processing system as indicated by input data used to generate acyclic graph 310, such as state information 222). Dashed vertical lines ascending from each time period/point/step of the horizontal time axis are shown intersecting corresponding predicted states.

Directed acyclic graph 310 may define streams of predicted states. The streams may include states that are predicted to occur in a series over time. For example, a first stream may be defined from the current state via arrows (e.g., edges) connecting predicted state 302A, predicted state 304A, and predicted state 306B, and a second stream may be defined from the current state via arrows connecting predicted state 302B, predicted state 304B, and predicted state 306B. Each stream may include an upstream predicted state and a downstream predicted state, where the downstream predicted state is predicted to occur after the upstream state occurs. In other words, the occurrence of the downstream state may be dependent on an occurrence of the upstream state.

For example, the data processing system may be operating in accordance with nominal operating standards in its current state. However, it may be predicted that, at time point 1, the data processing system will experience a heavy workload (e.g., predicted state 302A may include a high workload state where the data processing system is experiencing workloads that exceed maximum capacities for its hardware and/or software components). Given that the data processing system may be operating in predicted state 302A, it may be predicted that, due to cooling hardware age and/or performance metrics, the data processing system may be likely to experience temperatures that exceed nominal operating temperatures for the data processing system at time point 2 while in predicted state 304A (e.g., predicted state 304A may include an overheating state and may include cooling hardware failure event).

If the data processing system is left to operate in predicted state 304A for a given period of time (e.g., indicated by the horizontal axis and/or by metadata of predicted state 304A), then data processing system may experience predicted state 306A, which may include additional hardware failure events which may be catastrophic to the operation of the data processing system. For example, predicted state 306A may include a non-operational state for data processing system and/or may be associated with negative outcomes such as data loss and/or significant reduction in quality of provision of computer-implemented services.

Therefore, with respect to the stream described in the above example, predicted state 306A may occur downstream of upstream predicted states 304A and 302A, and the occurrence of predicted state 306A may depend on at least one of upstream predicted states 304A and 302A occurring.

Turning to FIG. 2C, a third data flow diagram in accordance with an embodiment is shown. The third data flow diagram may illustrate data used in and data processing performed during analysis of an acyclic graph (e.g., acyclic graph 226).

To analyze acyclic graph 226, graph analysis process 240 may be performed. During graph analysis process 240, streams of clusters may be identified and analyzed in order to identify needs for policy management. The streams (e.g., clusters thereof) may be associated with future outcomes (e.g., based on metadata for each cluster) for the data processing system. The future outcomes may include desired future outcomes or undesired future outcomes, defined in accordance with an operational goal for the data processing system.

To manage future outcomes (e.g., to avoid the undesired future outcomes and/or to promote the desired future outcomes), existing policies keyed to known operating states for the data processing system may be in place. However, in some cases, existing policies may require updates and/or new policies may need to be created in order to manage operating states that are not associated with adequately defined policies (e.g., previously unknown or new operating states). Therefore, streams of predicted future states that are not adequately managed by policies may be identified during graph analysis process 240.

In a first example, a stream of acyclic graph 226 may be identified. The stream may include a downstream cluster indicating a predicted future state for the data processing system that is associated with an undesired future outcome for the data processing system. The downstream cluster may not be adequately managed by a policy. For example, the downstream cluster may not be associated with a policy, or the downstream cluster may not be associated with a policy that, when invoked, reduces a likelihood of occurrence of predicted future events of the downstream cluster. Therefore, the downstream cluster may be identified for policy management during graph analysis process 240.

Continuing with the first example, an upstream cluster of the stream may be identified. Predicted future events of the upstream cluster may be predicted to occur prior to predicted future events of the downstream cluster. Therefore, to prevent occurrence of predicted future events of the downstream cluster, the upstream cluster may be identified for policy management (e.g., if the upstream cluster is not adequately managed by a policy). For example, a policy may be defined so that a likelihood of an occurrence of predicted future events of the upstream cluster is reduced while the policy is enforced.

In a second example, a stream of acyclic graph 226 may be identified. The stream may include a downstream cluster indicating a predicted future state for the data processing system that is associated with a desired future outcome for the data processing system. If the downstream cluster is not adequately managed by a policy that increases a likelihood of occurrence of predicted future events of the downstream cluster, then the downstream cluster may be identified for policy management. In addition, to further increase the likelihood of the occurrence of the predicted future events of the downstream cluster, then an upstream cluster of the stream that is not adequately managed by a policy may be identified for policy management during graph analysis process 240. For example, a policy may be defined so that a likelihood of an occurrence of predicted future events of the upstream cluster is not reduced (e.g., increased) while the policy is enforced.

During graph analysis process 240, acyclic graph 226 may be analyzed by a user. The user may include a user tasked with managing operation of the data processing system. Therefore, user input 242 may be provided to graph analysis process 240. For example, acyclic graph 226 may be displayed to the user via a GUI that may be browsed, and interacted with. Acyclic graph 226 may be displayed via the GUI as shown in FIG. 3A.

Returning to FIG. 3A, a user interface displaying directed acyclic graph 310 may illustrate streams of predicted future states for the data processing system over time, the streams indicating where different streams converge and diverge. For example, a first stream defined by the current state and predicted states 302A, 304B and 306B may converge and diverge with a second stream defined by the current state and predicted states 302B, 304B, and 306C (e.g., at predicted state 304B). The user interface may also indicate likelihoods of the different streams occurring.

To improve interpretability by the user, the edges (e.g., arrows) of directed acyclic graph 310 may be drawn in varying thicknesses and/or line styles to signify different types of metadata, such as likelihoods of transitions between predicted states. The likelihoods may be based on probabilities of occurrences of the predicted states (e.g., distributions of the predicted states). For example, an edge between an upstream predicted state and a downstream predicted state may indicate a ratio of a number of simulations that contributed to the upstream predicted state to a number of the simulations that also contributed to the downstream predicted state. The distribution of numbers of simulations contributing to different predicted states may indicate likelihoods of occurrences of the different predicted states. The likelihoods may be associated with different drawing styles based on predefined thresholds.

For example, edge 305A drawn in dashing may indicate that a likelihood of predicted future events of predicted state 306A occurring after predicted future events of predicted state 304A is low (e.g., less than 10% likely), whereas edge 301A drawn using a thick line may indicate that a likelihood of predicted future events of predicted state 302A occurring given the current state is high (e.g., more than 90% likely). Similarly, edge 301B drawn using a thin line may indicate that a likelihood of predicted future events of predicted state 302B occurring given the current state is moderate (e.g., between 10% and 90% likely).

Nodes (e.g., predicted states) of directed acyclic graph 310 may be sized based on statistical characterizations 208 and/or other metadata of the predicted states (e.g., based on predefined and/or customizable settings). For example, node size may indicate a number of simulations (e.g., predictions) that contributed to the cluster (e.g., a number of the predictions that indicate that a particular state is predicted to occur) thereby indicating a likelihood that the state associated with the cluster may occur. The nodes may be sized, colored, or patterned to visually communicate metadata to the user based on sets of rules and/or thresholds (e.g., alerts settings for specified ranges of metadata values).

For example, predicted state 306A may be patterned to indicate that predicted state 306A is not adequately managed by a policy, predicted state 306A may be patterned to indicate that predicted state 306C is associated with a negative outcome in view of operational goals, and/or predicted state 304A may be patterned to indicate that a policy keyed to predicted state 304A requires review. Therefore, the user may interact (e.g., click on) node 306A to obtain more information (e.g., metadata) and/or to identify (e.g., flag) predicted state 306A for policy management. For example, metadata for each cluster (e.g., predicted state) may include information regarding variability in predictions for each time partition of acyclic graph 310 (e.g., a standard deviation for all of the predictions partitioned into time point 1).

The user may provide user input (e.g., user input 242) while interacting with the GUI. For example, the user may provide input indicating that a stream of directed acyclic graph 310 violates an operational goal for the data processing system. The user input provided by the user may be responsive to at least one prompting by the GUI. For example, the user input may be provided based on node sizes, colors or patterns, and/or textual information associated with the nodes or edges of directed acyclic graph 310 that may indicate user intervention (e.g., input) is required. The user input may be used, at least in part, to define a policy for the data processing system.

Returning to FIG. 2C, once streams and/or clusters of acyclic graph 226 have been identified for policy management (e.g., by a user or other entity such as an automated analysis system), policy definition process 244 may be performed.

During policy definition process 244, policies may be defined based on streams and/or clusters of acyclic graph 226 that may violate operation goals of the data processing system. For example, the policies may be created, updated, and/or superseded using parameters and/or constraints obtained based on metadata of the identified streams and/or clusters of acyclic graph 226. During policy definition process 244, policy 246 may be defined. Policy 246 may, for example, be keyed to a state represented by a cluster identified as violating the operational goals for the data processing system and/or an upstream cluster thereof. Policy 246 may define actions for mitigating an occurrence of the state to which it is keyed and/or any other state predicted to occur thereafter.

For example, the policies defined during policy definition process 244 may include alerting policies defined to raise alarms when undesired predicted future states are likely (e.g., above a tolerance) for the data processing system, and/or remediation policies for managing operation of the data processing system in view of predicted future states.

Policy 246 may define how the data processing system is to operate (e.g., while in a specific state). For example, policy 246 may be defined such that likelihoods of occurrences of predicted future events of predicted future states of the data processing system are managed according to operational objectives (e.g., reduced or increased) while policy 246 is enforced. When policy 246 is enforced, operation of the data processing system may be updated in accordance with definitions of policy 246, and a computer-implemented service may be provided based on the updated operation of the data processing system.

Turning to FIG. 2D, a fourth data flow diagram in accordance with an embodiment is shown. The fourth data flow diagram may illustrate data used in and data processing performed during generation of plans (e.g., plan 260).

Consider a scenario in which policies (e.g., new and/or existing policies as described in FIG. 2C) may not appropriately account for desired function of the data processing system(s). The policies may not appropriately account for the desired function if, for example, the system described by the acyclic graph is highly complex (e.g., multiple data processing systems operating under frequently fluctuating conditions) and thereby challenging to predict.

For example, as a complexity of the system simulated by acyclic graph 226 increases, a number of predicted future operations (e.g., the predicted future states) represented by acyclic graph 226 may also increase. As the number of predicted future states increases, policies may increase in complexity and, therefore, a computational cost to define and implement the policies may also increase. Complexity of policy definition may increase, for example, if a same policy may be invoked for multiple predicted future states and/or multiple policies may be invoked for each predicted future state. Therefore, plans may be established for the system based on user input when interacting with the GUI.

To establish a plan, plan simulation process 252 and plan generation process 258 may be performed. During plan simulation process 252, user input 250 and acyclic graph 226 may be used to generate simulated acyclic graph 254. During plan simulation process 252, the user (e.g., an SME) may interact with a GUI that displays acyclic graph 226. As previously described in FIGS. 2B-2C, acyclic graph 226 may indicate any number of different potential future operation (e.g., different predicted future states) of potential future operations of a data processing system. Each cluster of acyclic graph 226 may represent a potential future operation. In addition, acyclic graph 226 may indicate probabilities of each different future operation of the potential future operations occurring (e.g., edges such as 301A shown in FIG. 3A). Refer to the discussion of FIG. 3A for additional details regarding edges and clusters of acyclic graphs.

Following presentation of the acyclic graph to the user and during plan simulation process 252, user input 250 may be obtained. To obtain user input 250, the user may choose to view a version of the GUI that allows for plan simulation. While in the plan simulation version of the GUI, the user may: (i) view the potential future operations via acyclic graph 226, (ii) obtain metadata for each of the potential future operations (e.g., an output from an LLM indicating conditions related to each potential future operation and statistical characterizations of individual and/or aggregate predictions of the plurality of predictions), and/or (iii) identify one or more of the potential future operations that are not compliant with operational goals for the data processing system(s).

Following identifying a potential future operation that is not compliant with the operational goals (e.g., may have negative outcomes), the user may: (i) identify a first node associated with the identified potential future operation, (ii) identify a second node upstream from the first node (e.g., occurring earlier in time and being connected to the first node via an edge and/or a stream), (iii) select a point in time associated with the second node, (iv) identify an action to be potentially performed at the point in time, and/or (v) perform other actions to populate a potential plan for the data processing system(s).

Therefore, user input 250 may include at least: (i) an action to be performed, (ii) a point in time at which the action is to be performed, (iii) a potential future operation that is not compliant with the operational goals, and/or (iv) other information.

For the selected point in time, the user may select an action (e.g., from an action library, by manual entry of a description of the action) to be potentially performed at that point in time. The action library and/or other portions of the GUI may be processed and presented to the user using a large language model (LLM) to generate human interpretable text describing the potential actions. By selecting the action, a potential plan may be generated via population by the action.

During plan simulation process 252, a digital twin (not shown) may be used to simulate potential future operations for the data processing system(s) in view of the potential plan to generate simulated acyclic graph 254. An example of acyclic graph 226 (without implementation of the potential plan) may be shown in FIG. 3A as acyclic graph 310 and an example of simulated acyclic graph 254 (with implementation of the potential plan) may be shown in FIG. 3B as acyclic graph 320.

For example, turning to FIG. 3A, the user may read metadata associated with node 304C (e.g., cluster 304C) and may determine that cluster 304C predicts a future state for the data processing system(s) in which 60% of drones are unable to perform desired functions (e.g., spraying pesticides). If the predicted state represented by cluster 304C occurs, a second future state represented by node 306C (e.g., cluster 306C) at time point 3 may have an increased likelihood of occurring. The second future state may include failure of the drones to complete a daily task.

The user may, therefore, desire to decrease a likelihood that the predicted future state represented by cluster 304C is to occur. To do so, the user may select time point 1 and may select an action (e.g., from an action library), the action including deploying additional drones to the geographical location in which the drones are operating. The user may then choose to simulate, using the digital twin, potential future operations of the data processing system(s) based on the potential plan of deploying additional drones at time point 1.

Turning to FIG. 3B, a second example of an acyclic graph is shown in accordance with an embodiment. Acyclic graph 320 may be similar to acyclic graph 310 described in FIG. 3A with the addition of node 304D (e.g., cluster 304D) and edge 305B. Acyclic graph 320 may be generated by a digital twin and may be intended to simulate potential future operations of the data processing system(s) with the potential plan being enforced (e.g., with the additional drones being deployed at time point 1).

By deploying additional drones at time point 1, a likelihood that 60% of drones may be unable to perform desired functions may be reduced (e.g., cluster 304C may appear smaller than in FIG. 3A due to fewer of the plurality of predictions indicating the potential future operation represented by cluster 304C).

New cluster 304D may be associated with a potential future state in which 45% of drones are unable to perform desired functions and edge 305B may be based on any number of statistical characterizations indicating a likelihood that cluster 304D will lead to node 306B (e.g., cluster 306B) at time point 3. Cluster 306B may represent an acceptable potential future operation in which the daily task is completed outside of a nominal time limit for the daily task.

Therefore, returning to FIG. 2D, acyclic graph 226 and simulated acyclic graph 254 may be presented to the user via the GUI to facilitate a visual interpretation of potential impacts of implementing the potential plan.

User input 256 may be obtained based on the potential impacts of implementing the potential plan represented by simulated acyclic graph 254. User input 256 and simulated acyclic graph 254 may be used to perform plan generation process 258. During plan generation process 258, it may be determined whether user input 256 indicates that the potential plan is acceptable. If user input 256 indicates that the potential plan is acceptable, plan 260 may be obtained based on the potential plan. If user input 256 indicates that the potential plan is not acceptable (e.g., via comparison to a list of operational goals for the data processing system(s)), plan simulation process 252 may be repeated using additional user feedback (e.g., represented by the dashed line connecting plan generation process 258 and plan simulation process 252). Any number of simulated acyclic graphs may be generated to simulate potential impacts of potential plans until the user indicates that an impact of a potential plan is acceptable.

During plan generation process (if user input 256 indicates that the potential plan is acceptable), one or more actions may be defined for plan 260 and a set of limitations may be defined for plan 260.

The one or more actions may include actions selected by the user via user input 250 during plan simulation process 252. The set limitations for the plan may include: (i) a first limitation indicating a point in time at which the plan is to be enforced, (ii) a second limitation indicating criteria for a statistical characterization of the potential future operations that are to be met in order for the plan to be enforced at the point in time, (iii) a third limitation indicating a threshold for a likelihood of an outcome for the plan occurring that must be met for the plan to be enforced at the point in time, and/or (iv) other information.

The set of limitations may be provided as part of user input 250, user input 256, and/or may be generated (automatically, semi-automatically) using at least a portion of user input 250 and/or user input 256. For example, the point in time selected by the user for performance of the action may be used as the first limitation. Therefore, the plan may not be invoked at a second point in time that is different from the point in time and the plan may not be invoked repeatedly (e.g., the plan may be designed to be invoked once).

In addition, the criteria for the statistical characterization may be based on at least one of the probabilities included in acyclic graph 226 (e.g., a probability that exceeds an acceptable degree of likelihood for an undesired future state). Therefore, user input 250 may indicate that at least one of the probabilities (e.g., the edges) is to be used as at least part of the statistical characterization. For example, the statistical characterization may include a quantification of a likelihood that a predicted future state is to occur. The second limitation may indicate that plan 260 is to be performed only if a quantification of a likelihood that an undesired predicted future state meets a threshold quantification of the likelihood (e.g., if the undesired future state is unlikely to occur based on the threshold quantification, plan 260 may not be enforced).

The third limitation may be based on a desired outcome (e.g., obtained from the SME, from another entity, automatically generated based on operational goals for the data processing system(s)). The desired outcome may include, for example, a predicted future state (e.g., potential future operation) downstream of one or more other predicted future states (e.g., at least one of nodes 306A, 306B, and 306C shown in FIG. 3B). If a likelihood that a desired predicted future state (e.g., described by node 306B) is below a threshold, the plan may not be enforced.

Consequently, when plan 260 is enforced, activity (e.g., operation) of the data processing system(s) may be updated in accordance with plan 260, and computer-implemented services may be provided based on the updated activity of the data processing system.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flow diagram shown in FIG. 2D, at least two acyclic graphs representing a plurality of predicted future events for a data processing system may be used to manage operation of the data processing system using proactive plan generation in a manner that improves a likelihood of achieving operational goals for the data processing system.

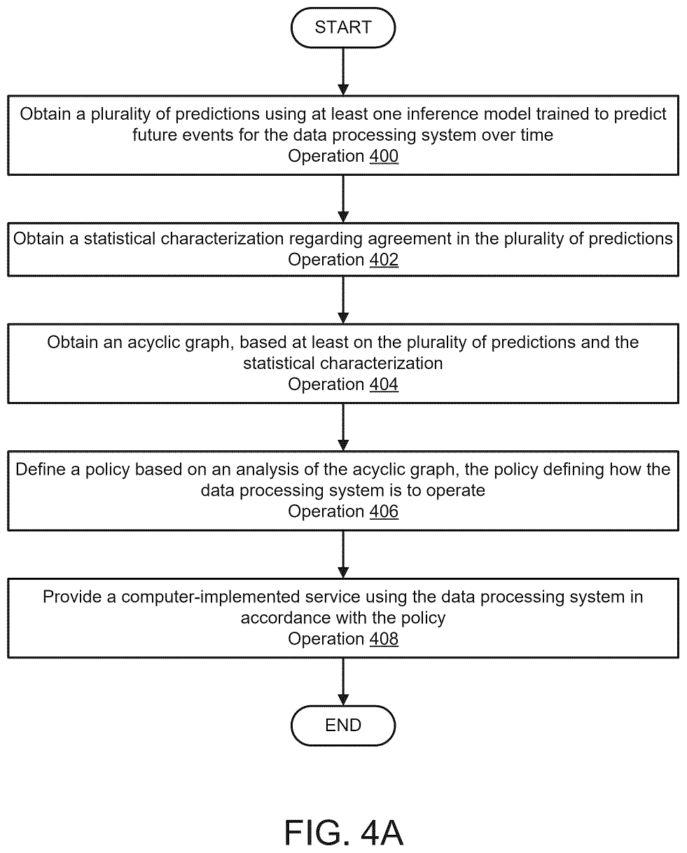

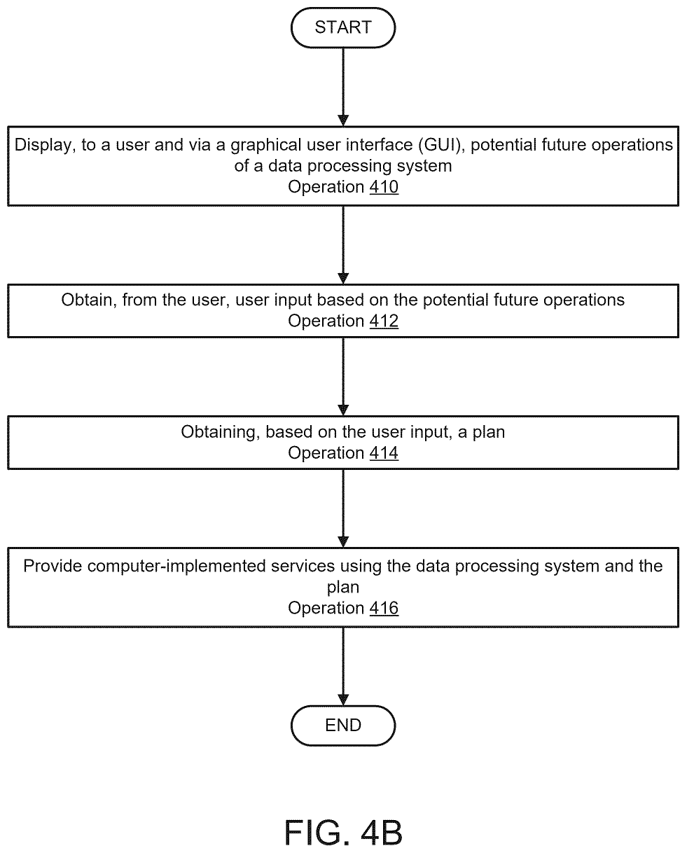

Turning to FIG. 4A, a first flow diagram illustrating a method in accordance with an embodiment is shown. The flow diagram may illustrate various operations performed while managing operation of a data processing system.

At operation 400, a plurality of predictions may be obtained using at least one inference model trained to predict future events for the data processing system over time. The plurality of predictions may be obtained by (i) reading the plurality of predictions from storage, (ii) receiving the plurality of predictions (e.g., from another device), (iii) generating the plurality of predictions, and/or (iv) other methods.

For example, the plurality of predictions may be generated by (i) obtaining input data, (ii) using the input data as ingest for the at least one inference model (e.g., feeding the input data into the at least one inference model to generate predictions), (iii) obtaining the plurality of predictions as output of the at least one inference model (e.g., generating the predictions by the inference model using the input data). Refer to the discussion of FIG. 2A for more details regarding obtaining a plurality of predictions.

At operation 402, a statistical characterization regarding agreement in the plurality of predictions may be obtained. The statistical characterization may be obtained by (i) reading the statistical characterization from storage, (ii) receiving the statistical characterization (e.g., from another device), (iii) generating the statistical characterization, and/or (iv) other methods.

For example, the statistical characterization may be generated by (i) aggregating the plurality of predictions into a dataset, (ii) using statistical methods to obtain the statistical characterization of the dataset, (iii) providing the dataset to another device and receiving the statistical characterization in response, and/or (iv) other methods. Using the statistical methods may include performing statistical calculations (e.g., averaging, population distribution calculations, hypothesis testing, regression, analysis of variance). For example, the statistical characterization may include a mean, median, mode, standard deviation and/or any other type of statistical characterization of the dataset usable to determine agreement in the plurality of predictions.

At operation 404, an acyclic graph may be obtained, based at least on the plurality of predictions and the statistical characterization. The acyclic graph may be obtained by performing a graph population process similar to graph population process 220 of FIG. 2B and/or by other methods. For example, obtaining the acyclic graph may include (i) defining time partitions for the acyclic graph, and for each time partition of the time partitions (ii) defining clusters of predicted future events based, in part, on the statistical characterization and criteria including requirements corresponding to quantities of the statistical characterization.

Defining the time partitions for the acyclic graph may include obtaining a time partitioning schema (e.g., from storage, from another entity) and using a time partitioning schema to separate the predicted future events by units and/or ranges of time as defined by the partitioning schema. For example, the time partitioning schema may define buckets of time (e.g., durations or points in time), and time information included in the predicted future events may be used to label each predicted future event with its corresponding bucket.

Defining clusters of predicted future events may include implementing a clustering algorithm (e.g., k-means clustering, hierarchical clustering, rule-based clustering). For example, the clustering algorithm may use the statistical characterization (e.g., any number of statistical characterizations for the plurality of inferences) to assess levels of agreement between the predicted future events corresponding to each time bucket (e.g., time partition), and may cluster the predicted future events in accordance with requirements of the criteria associated with the levels of agreement (e.g., the statistical characterization).

For example, the requirements may include thresholds for levels of agreement, and the thresholds may be used to evaluate whether predicted future states should be clustered based on values of levels of agreement when compared to the thresholds. For more details regarding defining time partitions and clustering predicted future events, refer to the discussion of FIGS. 2B-3.

Obtaining the acyclic graph may include relating future predicted states for the data processing system. For example, the clusters of predicted future events may define predicted future states for the data processing system, each cluster including metadata (e.g., information regarding the predicted future events that contribute to the cluster, policy information regarding the defined predicted future states, etc.). Therefore, the acyclic graph may be obtained by populating a template for an acyclic graph by assigning clusters as nodes of the acyclic graph, and using the metadata of each of the clusters to define relationships between the clusters (e.g., edges of the acyclic graph).

Therefore, the acyclic graph may include a plurality of nodes connected by a plurality of edges, the plurality of nodes representing predicted future states for the data processing system, and the plurality of edges representing relationships between the predicted future states, such as likelihoods of transitions between predicted future states over the defined time partitions.

The acyclic graph may define streams, the streams including future states that are predicted to occur in a series over time, and each stream of the streams including an upstream predicted future state and a downstream predicted future state, the downstream predicted future state being predicted to occur after the upstream predicted future state occurs. For example, the occurrence of the downstream predicted future state may be dependent on an occurrence of the upstream predicted future state.

At operation 406, a policy may be defined based on an analysis of the acyclic graph. The policy may be defined by performing processes similar to graph analysis process 240 and policy definition process 244 of FIG. 2C and/or by other methods. The acyclic graph may be analyzed by an automated entity (e.g., a device hosting software usable to analyze the acyclic graph) and/or by a user (e.g., an SME).

For example, defining the policy may include (i) obtaining, using the acyclic graph, a GUI illustrating streams of predicted future events, the streams indicating where different streams converge and diverge, and likelihoods of the streams occurring, (ii) presenting the GUI to a user to obtain user input, and/or (iii) populating the policy using at least the user input.

Obtaining the GUI may include (i) receiving instructions (e.g., from another entity) responsible for generating and populating the GUI, (ii) executing instructions hosted by hardware resources of a device to load software for the GUI, and/or (iii) selecting the acyclic graph (e.g., a data structure) using the GUI. Presenting the GUI to the user may include loading the selected acyclic graph to be displayed by the GUI (e.g., using a peripheral device of the device such as a monitor) and prompting the user (e.g., via a popup interface, via a message, via a notification in an application on a device) with instructions for accessing the GUI.

The user input may be obtained, for example, in response to at least one prompting by the GUI, the prompting indicating that the at least one of the streams would violate an operational goal for the data processing system. The user may provide the user input, for example, via an interaction with one or more human interface devices (e.g., a mouse, a keyboard, a touch screen) and the user input may be obtained by via interpretation of the interaction and/or via other methods. The user input may include, for example, a selected predicted future event (e.g., metadata thereof) that may be used to define the policy. For more details regarding defining the policy using the acyclic graph, refer to the discussion of FIGS. 2C and 3A.

In a first example, defining the policy may include (i) identifying a first downstream cluster of a first stream of the acyclic graph, the first downstream cluster being associated with an undesired future outcome for the data processing system (ii) identifying a first upstream cluster of the first stream, and/or (iii) populating the policy so that a likelihood of an occurrence of predicted future events of the first upstream cluster is reduced while the policy is enforced.

In a second example, defining the policy may include (i) identifying a second downstream cluster of a second stream of the acyclic graph, the second downstream cluster being associated with a desired future outcome for the data processing system (ii) identifying a second upstream cluster of the second stream, and/or (iii) populating the policy so that a likelihood of an occurrence of predicted future events of the second upstream cluster is not reduced while the policy is enforced.

Identifying the (first/second) downstream cluster of the (first/second) stream associated with an (undesired/desired) outcome may include querying metadata for each cluster of the acyclic graph. For example, the user may view a display of the acyclic graph (e.g., via the GUI), in which clusters of the acyclic graph are colored or patterned by outcome associated with the cluster. The user may identify the downstream cluster based on the color or pattern of the cluster and may select the downstream cluster (e.g., via an interaction with a human interface device) to obtain the metadata and/or a summary of the metadata.

Identifying the (first/second) upstream cluster of the (first/second) stream may include identifying the stream (e.g., based on metadata of each cluster and/or a visual identification). For example, the user may interact with the GUI (e.g., provide feedback in the form of instruction) to only display clusters for a particular stream (e.g., based on a stream identifier for the downstream cluster). A cluster that occurs prior to the downstream cluster (e.g., the upstream cluster) may be identified by querying metadata such as time information associated with each cluster and/or by the user viewing the time axis of the acyclic graph.

In a third example, defining the policy may include providing the acyclic graph to another entity for analysis. The entity may include a device that hosts software usable to analyze the acyclic graph. As a result of the analysis, the entity may provide information regarding clusters, streams, and/or policies (e.g., suggested parameters or constraints thereof) that require user review.

Populating the policy to manage likelihoods of occurrences of predicted future events (e.g., predicted future states) may include (i) querying metadata for any identified clusters (e.g., the upstream cluster and/or the downstream cluster), (ii) obtaining parameters and/or constraints based on the metadata (e.g., statistical characterizations of the upstream cluster), (iii) selecting a policy template keyed to the predicted future event of the upstream cluster, and/or (iii) using the parameters and/or constraints to update the policy template. For example, updating the policy template may include modifying criteria (e.g., thresholds) of the policy template and/or defining actions associated with the policy for updating operation of the data processing system. The policy may define how the data processing system is to operate when placed in the predicted state.

At operation 408, a computer-implemented service may be provided using the data processing system in accordance with the policy. For example, providing the computer-implemented service may include (i) performing functions of the data processing system in a modified state defined by the policy (e.g., at a reduced power, at a reduced processor frequency), (ii) performing the functions of the data processing system in a different location (e.g., in a location where the predicted future state is not likely to occur), (iii) performing the functions of the data processing system at a different time (e.g., before and/or after a time range associated with the predicted future state), and/or (iv) other methods.

The method may end following operation 408.

Turning to FIG. 4B, a second flow diagram illustrating a method in accordance with an embodiment is shown. The flow diagram may illustrate various operations performed while managing operation of a data processing system. To manage the operation of the data processing system, a plan may be generated for the data processing system.

At operation 410, potential future operations of a data processing system may be displayed to a user and via a GUI. Displaying the potential future operations of the data processing system via the GUI may include: (i) providing instructions to the user for accessing the GUI (e.g., via a pop up interface, via a message, via a notification through an application on a device), (ii) executing instructions for hardware and/or software components usable to generate and/or display the GUI illustrating the acyclic graph (e.g., populated as described in FIG. 4A) on a display of a device (e.g., a monitor), (iii) providing instructions to another entity responsible for executing software usable to display the GUI, and/or (iv) other methods.

At operation 412, user input may be obtained from the user based on the potential future operations. Obtaining the user input may include: (i) reading the user input from storage, (ii) receiving the user input via any number of selections made by the user while interacting with the GUI (e.g., user interactions may be interpreted by an LLM and stored as human interpretable text in storage, may be provided to the user), (iii) receiving at least a portion of the user input from another entity (e.g., via a message over a communication system), and/or (iv) other methods.

At operation 414, a plan may be obtained based on the user input. The plan may be for a point in time indicated by the GUI, may be limited for use by the data processing system based on a statistical characterization of the potential future operations of the data processing system, and may define activity of the data processing system at the point in time.

Obtaining the plan may include: (i) updating the GUI to indicate an impact of a potential plan defined by the user (e.g., from the user input), (ii) obtaining, from the user, confirmation regarding acceptability of the impact, and/or (iii) other methods. If the impact is acceptable (e.g., as indicated by feedback from the user), obtaining the plan may include using the potential plan as the plan. If the impact is not acceptable (e.g., as indicated by feedback from the user), obtaining the plan may include evaluating other potential plans defined by the user to obtain the plan.

Updating the graphical user interface may include: (i) updating nodes of an acyclic graph of the GUI to indicate an occurrence of a new potential future operation based on the potential plan, (ii) updating edges between the nodes the acyclic graph of the GUI to indicate a change in likelihood of occurrence of the potential future operations based on the potential plan, (iii) adding an acyclic graph that indicates updated potential future operations of the data processing system with the plan being enforced by the data processing system (e.g., an updated acyclic graph), and/or (iv) other methods.

Updating the nodes of the acyclic graph may include: (i) using the acyclic graph and the potential plan as ingest for a model (e.g., a digital twin trained to simulate future operation of the data processing system), (ii) obtaining a plurality of simulated predictions as an output from the model, the plurality of simulated predictions indicating potential future states of the data processing system over time when the potential plan is implemented, (iii) obtaining a statistical characterization for the plurality of simulated predictions (e.g., mean values, numbers of predictions associated with each potential future state, standard deviations indicating variability (e.g., agreement) within the plurality of simulated predictions), (iii) generating an updated set of nodes based on the plurality of simulated predictions and the statistical characterization for the plurality of simulated predictions, and/or (iv) other methods. Refer to FIGS. 2D and 3B for a discussion of updated nodes based on simulated predictions.

Updating the edges between the nodes of the acyclic graph may include generating, based on probabilities that each potential future operation will occur (e.g., from the statistical characterization for the plurality of simulated predictions), an updated set of edges. Obtaining the updated set of edges may include: (i) obtaining new edges not previously included in the acyclic graph, (ii) modifying metadata associated with each edge of the edges based on the probabilities (e.g., modifying thickness of edges to indicate relative likelihoods that downstream predicted future states will occur based on occurrence of upstream predicted future events), and/or (iii) other methods.

Updating the edges may also include providing the updated nodes and the statistical characterization for the plurality of simulated predictions to another entity responsible for generating the updated edges.

Adding the updated acyclic graph that indicates updated potential future operations of the data processing system with the plan being enforced by the data processing system may include: (i) generating the updated acyclic graph that indicates updated potential future operations of the data processing system with the plan being enforced (e.g., based on the updated nodes and the updated edges), (ii) populating a GUI with the updated acyclic graph that indicates the updated potential future operations of the data processing system with the plan being enforced and a second acyclic graph that indicates potential future operations of the data processing system without the plan being enforced, (iii) providing the updated acyclic graph and the second acyclic graph to another entity responsible for populating the GUI for viewing by users, and/or (iv) other methods.

Obtaining the confirmation from the user may include: (i) receiving feedback from the user (e.g., via the user making a selection on the GUI via use of one or more human interface devices), (ii) reading the confirmation from storage, (iii) receiving the confirmation from another entity, and/or (iv) other methods.

Using the potential plan as the plan may include: (i) obtaining any number of limitations for the plan (e.g., from the user, from another simulation and/or by automatically populating the limitations based on previously provided preferences of the user and/or another entity), (ii) generating a log entry including at least one or more actions included in the plan and the limitations for the plan, (iii) providing the log entry to another entity responsible for implementing the plan, and/or (iv) other methods.

Evaluating other potential plans defined by the user to obtain the plan may include: (i) receiving second user input indicating second potential future actions to be performed to modify predicted future states for the data processing system, (ii) generating a third acyclic graph for interpretation by the user and displaying potential impacts of the second potential future actions, (iii) receiving feedback from the user regarding the second potential future actions, and/or (iv) other methods.

Any number of additional acyclic graphs may be generated and presented to the user as part of the plan generation process. Therefore, the user may initiate simulation of impacts of any number of potential actions on the potential future states for the data processing system while interacting with the GUI.

At operation 416, computer-implemented services may be provided using the data processing system and the plan. Providing the computer-implemented services may include instructing the data processing system to perform the plan. Instructing the data processing system to perform the plan may include providing actions included in the plan, limitations for the plan, and/or other information regarding the plan to the data processing system (e.g., transmission via a message, storing in a shared storage architecture for subsequent retrieval by the data processing system).

For example, providing the computer-implemented service may also include (i) performing functions of the data processing system in a modified state defined by the plan (e.g., at a reduced power, at a reduced processor frequency), (ii) performing the functions of the data processing system in a different location (e.g., in a location where the predicted future state is not likely to occur), (iii) performing the functions of the data processing system at a different time (e.g., before and/or after a time range associated with the predicted future state), and/or (iv) other methods.

The method may end following operation 416.

Thus, as illustrated above, embodiments disclosed herein may provide systems and methods usable to manage plan definition for a data processing system based on acyclic graph populated using predictions regarding future states of the data processing system. By doing so, the plans may be managed so that operational objectives for the data processing system are more likely to be met, and operation of the data processing systems may be updated in accordance with the plans to hedge against a risk of undesired outcomes associated with predicted future states.

Any of the components illustrated in FIGS. 1-3B may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random-access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs, or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
displaying, to a user and via a graphical user interface, potential future operations of the data processing system;
obtaining, from the user, user input based on the potential future operations of the data processing system;
obtaining, based on the user input, a plan that:
is for a point in time indicated by the graphical user interface,
is limited for use by the data processing system based on a statistical characterization of the potential future operations of the data processing system, and
defines activity of the data processing system at the point in time; and
providing computer-implemented services using the data processing system and the plan.

2. The method of claim 1, wherein the graphical user interface comprises an acyclic graph indicating any number of different potential future operation of the potential future operations, and probabilities of each different future operation of the potential future operations occurring.

3. The method of claim 2, wherein the user input indicates that at least one of the probabilities is to be used as at least a part of the statistical characterization.

4. The method of claim 1, wherein obtaining the plan comprises:
updating the graphical user interface to indicate an impact of a potential plan defined by the user;
obtaining, from the user, confirmation regarding acceptability of the impact; and
in a first instance of the obtaining where the impact is acceptable:
using the potential plan as the plan; and
in a second instance of the obtaining where the impact is not acceptable:
evaluating other potential plans defined by the user to obtain the plan.

5. The method of claim 4, wherein updating the graphical user interface comprises:
updating nodes of an acyclic graph of the graphical user interface to indicate an occurrence of a new potential future operation based on the potential plan.

6. The method of claim 4, wherein updating the graphical user interface comprises:
updating edges between nodes of an acyclic graph of the graphical user interface to indicate a change in likelihood of occurrence of the potential future operations based on the potential plan.

7. The method of claim 4, wherein updating the graphical user interface comprises:
adding an acyclic graph that indicates updated potential future operations of the data processing system with the plan being enforced by the data processing system.

8. The method of claim 7, wherein the graphical user interface comprises a second acyclic graph that indicates the potential future operations of the data processing system without the plan being enforced by the data processing system.

9. The method of claim 1, wherein providing the computer-implemented services comprises:
instructing the data processing system to perform the plan.

10. The method of claim 1, wherein the plan is further limited for use based on a likelihood of an outcome for the plan occurring.

11. A non-transitory machine-readable medium having instructions stored therein, which when executed by a processor, cause the processor to perform operations for managing operation of a data processing system the operations comprising:
displaying, to a user and via a graphical user interface, potential future operations of the data processing system;
obtaining, from the user, user input based on the potential future operations of the data processing system;
obtaining, based on the user input, a plan that:
is for a point in time indicated by the graphical user interface,
is limited for use by the data processing system based on a statistical characterization of the potential future operations of the data processing system, and
defines activity of the data processing system at the point in time; and
providing computer-implemented services using the data processing system and the plan.

12. The non-transitory machine-readable medium of claim 11, wherein the graphical user interface comprises an acyclic graph indicating any number of different potential future operation of the potential future operations, and probabilities of each different future operation of the potential future operations occurring.

13. The non-transitory machine-readable medium of claim 12, wherein the user input indicates that at least one of the probabilities is to be used as at least a part of the statistical characterization.

14. The non-transitory machine-readable medium of claim 11, wherein obtaining the plan comprises:
updating the graphical user interface to indicate an impact of a potential plan defined by the user;
obtaining, from the user, confirmation regarding acceptability of the impact; and
in a first instance of the obtaining where the impact is acceptable:
using the potential plan as the plan; and
in a second instance of the obtaining where the impact is not acceptable:
evaluating other potential plans defined by the user to obtain the plan.

15. The non-transitory machine-readable medium of claim 14, wherein updating the graphical user interface comprises:
updating nodes of an acyclic graph of the graphical user interface to indicate an occurrence of a new potential future operation based on the potential plan.

16. A data processing system, comprising:
a processor; and
a memory coupled to the processor to store instructions, which when executed by the processor, cause the processor to perform operations, the operations comprising:
displaying, to a user and via a graphical user interface, potential future operations of the data processing system;
obtaining, from the user, user input based on the potential future operations of the data processing system;
obtaining, based on the user input, a plan that:
is for a point in time indicated by the graphical user interface,
is limited for use by the data processing system based on a statistical characterization of the potential future operations of the data processing system, and
defines activity of the data processing system at the point in time; and
providing computer-implemented services using the data processing system and the plan.

17. The data processing system of claim 16, wherein the graphical user interface comprises an acyclic graph indicating any number of different potential future operation of the potential future operations, and probabilities of each different future operation of the potential future operations occurring.

18. The data processing system of claim 17, wherein the user input indicates that at least one of the probabilities is to be used as at least a part of the statistical characterization.

19. The data processing system of claim 16, wherein obtaining the plan comprises:
updating the graphical user interface to indicate an impact of a potential plan defined by the user;
obtaining, from the user, confirmation regarding acceptability of the impact; and
in a first instance of the obtaining where the impact is acceptable:
using the potential plan as the plan; and
in a second instance of the obtaining where the impact is not acceptable:
evaluating other potential plans defined by the user to obtain the plan.

20. The data processing system of claim 19, wherein updating the graphical user interface comprises:
updating nodes of an acyclic graph of the graphical user interface to indicate an occurrence of a new potential future operation based on the potential plan.
